(19) United States
(12) Patent Application Publication
(10) Pub. No.: US 2015/0184117 A1
(43) Pub. Date: Jul. 2, 2015

(54) DEVICE FOR ACCELERATED AGING OF WINE

(71) Applicants: Ronald C. STITES, Brighton, CO (US); Erik J. STITES, Denver, CO (US); David GILL, Salt Lake City, UT (US); Andrew BENWELL, Pacifica, CA (US); Stephen M. STITES, Wentzville, MO (US)

(72) Inventors: Ronald C. STITES, Brighton, CO (US); Erik J. STITES, Denver, CO (US); David GILL, Salt Lake City, UT (US); Andrew BENWELL, Pacifica, CA (US); Stephen M. STITES, Wentzville, MO (US)

(21) Appl. No.: 14/585,175

(22) Filed: Dec. 29, 2014

Related U.S. Application Data
(62) Division of application No. 61/922,437, filed on Dec. 31, 2013.
(60) Provisional application No. 61/947,405, filed on Mar. 3, 2014.

(51) Int. Cl. C12H 1/16

(52) U.S. Cl. CPC C12H 1/165

(57) ABSTRACT

A device for the accelerated aging of wine consisting of a low direct-current voltage applied to inert electrodes is described herein. The device improves the taste of many wines by accelerating the natural aging process which is primarily a free-radical-induced reaction involving the polymerization and precipitation of polyphenols such as tannins, thus reducing the astringency and improving the taste of many full bodied wines. The device can be miniaturized for use with single servings or scaled up to be applied to large commercial batches. The device has the added feature of being able to reduce the sulfite content of some wines, reducing foul tastes caused by free sulfur dioxide and possibly reducing negative reactions to sulfite for some users of wine.

### PRIORITY DATA

This patent application is a non-provisional application with priority to U.S. Provisional Patent App. No. 61/922,437, filed Dec. 31, 2013, and to U.S. Provisional Patent App. No. 61/947,405, filed Mar. 3, 2014, each of which is hereby incorporated by reference herein.

### FIELD OF THE INVENTION

The present invention generally relates to methods and apparatus for accelerating the aging of wine and other foods or beverages.

### BACKGROUND OF THE INVENTION

Certain wines are amenable to aging. These are generally (but not exclusively) red wines that contain certain astringent and poor-tasting organic molecules (especially tannins, anthocyanins, and other flavonoids) that slowly react with themselves, other organic molecules (including alcohols, aldehydes, and proteins) or small amounts of oxygen, resulting in improved taste. This is the natural wine aging process that is done in cellars. These reactions are very complex and depend on a number of factors including pH, oxygen content, amount and types of organic compounds present, storage conditions, and even bottle type. These reactions may be initiated by random energetic events such as cosmic radiation and natural radioactivity (such as ⁴⁰K decay) acting on major components, creating free radicals. These randomly generated free radicals (such as H— and OH—) can pass their energy to organic molecules, and the reaction path is ultimately controlled by thermodynamics.

In general, flavor-causing molecules are free-radical reactive. They often contain aromatic rings with attached or incorporated heteroatoms such as oxygen, nitrogen, or sulfur. These molecules readily accept or donate electrons making them redox active. Hence, natural aging is likely dominated by free radical/redox chemistry. Unfortunately, natural aging is slow and somewhat unpredictable.

What is desired is to mimic the natural aging process by creating free radicals in an effective and safe (e.g., radiation-free) manner. In order to accelerate the natural aging process, initiation of free-radical formation is required. There are a number of ways to create free radicals. One technique that has been investigated is the use of pulsed electric fields. See Chen et al., “Effect of Pulsed Electric Fields on Proanthocyanidins in Young Red Wine,” Proceedings of the 9th International Conference on Properties and Applications of Dielectric Materials (China), 2009; Puértolas et al., “Effect of Pulsed Electric Field Processing of Red Grapes on Wine Chromatic and Phenolic Characteristics during Aging in Oak Barrels,” J. Agric. Food Chem. 2010,58, 2351-2357 2351; and Zeng et al., “The effects of AC electric field on wine maturation,” Innovative Food Science and Emerging Technologies 9 (2008) 463-468. These techniques use high voltage and alternating current and require expensive, high-power equipment.

Prior art has employed AC voltages to age the wine. These methods create significant AC currents and can waste power and even heat the wine. This makes it difficult to miniaturize the device for use with a single bottle of wine or power the device with a small battery. Improvements are desired to provide practical and safe devices and methods to accelerate the aging of wines.

### SUMMARY OF THE INVENTION

In some variations, the invention provides a device for accelerating the aging of wine, the device comprising:
(a) a direct-current electrical potential circuit comprising a solid-state voltage controller, a positive electrode, a negative electrode, and optionally a resistor element;
(b) an electrical power input that is adaptable to an external power supply; and
(c) a switch, in operable communication with the electrical power input, configured to pass electrical current from the external power supply to the positive and negative electrodes,
wherein the positive and negative electrodes are each capable of being at least partially immersed in a selected volume of wine for accelerated aging.

In some embodiments, the solid-state voltage controller is a light-emitting diode, a silicon diode, or a zener diode. For example, the solid-state voltage controller may be a light-emitting diode having a forward voltage drop that is configured to control voltage to the positive and negative electrodes. The solid-state voltage controller may be configured for fixed direct-current voltage control or for variable direct-current voltage control.

The positive electrode and negative electrode may each independently include one or more materials selected from the group consisting of graphite, glassy carbon, carbon fibers, gold, nickel, titanium, cobalt, and transition-metal oxides. In certain embodiments, the positive electrode and negative electrode each consist essentially of carbon (such as high-purity graphite). In some embodiments, the cathode is high-purity graphite while the anode is gold.

In some embodiments of the invention, the external power supply is a battery. Other sources of external power may be utilized, including (but not limited to) solar power, fuel cells, portable generators, AC-to-DC converters, and so on. The source may also be the direct output from a micro-chip, in certain embodiments.

The device may be portable. In some embodiments, the device includes, or is linkable directly or wirelessly to, a microcontroller board and/or a programmable micro-processor chip.

In some embodiments, the device further includes one or more output ports on the microcontroller board or programmable micro-processor chip, configured to provide both control and electrical power to the device.

In some embodiments, the device further includes an input port on the microcontroller board or the programmable micro-processor chip, configured to sense the aging condition of the selected volume of wine.

The present invention, in some variations, also provides a method of accelerating the aging of wine, the method comprising:
(a) selecting a volume of wine to be aged;
(b) providing a direct-current electrical potential circuit comprising a solid-state voltage controller (such as a light-emitting diode), a positive electrode, a negative electrode, and optionally a resistor element;
(c) at least partially immersing the positive and negative electrodes into the volume of wine;
(d) passing electrical current from an external power supply to the positive and negative electrodes, to induce free-radical formation at an electrode surface; and
(e) treating the volume of wine for an effective amount of time to age the wine.

In some embodiments, in step (d), direct-current voltage (arising from the direct-current electrical potential circuit) is less than 3.0 volts, such as about 2.4 volts or less. In certain embodiments, the direct-current voltage is about 1.8 volts or less.

The electrical current amperage in step (d) may vary, depending on the volume of wine to be treated, as well as on the desired amount of aging. When the volume of wine is a glass of wine, the electrical current in step (d) may be selected from about 20 μA to about 100 μA. When the volume of wine is a bottle of wine, the electrical current in step (d) may be selected from about 1 mA to about 40 mA. When the volume of wine is a barrel or vessel of wine, the electrical current in step (d) may be selected from about 1 A to about 5 A.

The free-radical formation induced in step (d) may be effective to remove tannins by precipitation or other chemical reactions and/or to remove sulfites by disproportionation or other chemical reactions.

The effective amount of time in step (e) may be selected from about 1 minute to about 60 minutes, such as about 5 minutes to about 30 minutes.

In some embodiments, the method further comprises retrieving, from a remote database, recipe instructions or control parameters pertaining to one or more of steps (b) to (e).

The method may utilize a device comprising:
(a) a direct-current electrical potential circuit comprising a solid-state voltage controller, a positive electrode, a negative electrode, and optionally a resistor element;
(b) an electrical power input that is adaptable to an external power supply; and
(c) a switch, in operable communication with the electrical power input, configured to pass electrical current from the external power supply to the positive and negative electrodes,
wherein the positive and negative electrodes are each capable of being at least partially immersed in a selected volume of wine for accelerated aging.

In some embodiments, the method further comprises sensing an aging condition of the volume of wine. For example, the device may further include a microcontroller board or programmable micro-processor chip, configured to sense the aging condition of the selected volume of wine while it is being treated.

The invention also provides a wine product produced by a process comprising:
(a) selecting a volume of wine to be aged;
(b) providing a direct-current electrical potential circuit comprising a solid-state voltage controller (such as a light-emitting diode), a positive electrode, a negative electrode, and optionally a resistor element;
(c) at least partially immersing the positive and negative electrodes into the volume of wine;
(d) passing electrical current from an external power supply to the positive and negative electrodes, to induce free-radical formation at an electrode surface; and
(e) treating the volume of wine for an effective amount of time to age the wine, thereby producing a wine product.

In some variations, the invention provides a device for accelerating the aging (or other beneficial chemical reaction) of a food or beverage, the device comprising:
(a) a direct-current electrical potential circuit comprising a solid-state voltage controller, a positive electrode, a negative electrode, and optionally a resistor element;
(b) an electrical power input that is adaptable to an external power supply; and
(c) a switch, in operable communication with the electrical power input, configured to pass electrical current from the external power supply to the positive and negative electrodes,
wherein the positive and negative electrodes are each capable of being at least partially immersed in a selected volume of a food or beverage for accelerated aging.

The present invention, in some variations, also provides a method of accelerating the aging (or other beneficial chemical reaction) of a food or beverage, the method comprising:
(a) selecting a volume of a food or beverage to be aged;
(b) providing a direct-current electrical potential circuit comprising a solid-state voltage controller (such as a light-emitting diode), a positive electrode, a negative electrode, and optionally a resistor element;
(c) at least partially immersing the positive and negative electrodes into the volume of the food or beverage;
(d) passing electrical current from an external power supply to the positive and negative electrodes, to induce free-radical formation at an electrode surface; and
(e) treating the volume of the food or beverage for an effective amount of time to age the food or beverage.

### BRIEF DESCRIPTION OF THE DRAWINGS

FIG. 1 shows an exemplary light-emitting diode (LED) circuit in some wine-aging devices of the invention.

FIG. 2 depicts an exemplary wine-aging device, in some embodiments.

FIG. 3 presents a photograph of a wine-aging device, described in Example 1.

FIG. 4 illustrates a circuit configuration to provide device control based on DC voltage and treatment time.

FIG. 5 illustrates a circuit configuration to provide device control based on DC voltage and direct electrical current.

FIG. 6 shows a simplified schematic of an exemplary computer system that may be utilized in some embodiments.

FIG. 7 depicts a copper strike bath set-up used for making connections to high-purity graphite electrodes, in Example 3.

FIG. 8 presents a photograph of a 5-position test rigs, in Example 3.

FIG. 9 presents a photograph of a single-glass device, in Example 3.

FIG. 10 shows cyclic voltammetry data for red wine treated with a device provided by some embodiments, such as in Example 5.

FIG. 11 shows cyclic voltammetry data for white wine treated with a device provided by some embodiments, such as in Example 5.

FIG. 12 shows cyclic voltammetry data (Example 5) for a sulfite solution along with the same electrodes as used in FIGS. 10 and 11.

### DETAILED DESCRIPTION OF EMBODIMENTS OF THE INVENTION

The devices, apparatus, methods, and systems of the present invention will be described in detail by reference to various non-limiting embodiments and figures.

This description will enable one skilled in the art to make and use the invention, and it describes several embodiments, adaptations, variations, alternatives, and uses of the invention. These and other embodiments, features, and advantages of the present invention will become more apparent to those skilled in the art when taken with reference to the following detailed description of the invention in conjunction with the accompanying drawings.

As used in this specification and the appended claims, the singular forms “a,” “an,” and “the” include plural referents unless the context clearly indicates otherwise. Unless defined otherwise, all technical and scientific terms used herein have the same meaning as is commonly understood by one of ordinary skill in the art to which this invention belongs. As intended herein, “receiving” shall be broadly construed as including “providing,” “sensing” (e.g., using a sensor attached to a computer), “calculating” (e.g., using executable code in a computer), and so on.

Unless otherwise indicated, all numbers expressing parameters, conditions, results, and so forth used in the specification and claims are to be understood as being modified in all instances by the term “about.” Accordingly, unless indicated to the contrary, the numbers set forth in the following specification and attached claims are approximations that may vary depending upon specific algorithms and calculations.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” limits the scope of a claim to the specified elements or method steps, plus those that do not materially affect the basis and novel characteristic(s) of the claimed subject matter.

With respect to the terms “comprising,” “consisting of,” and “consisting essentially of,” where one of these three terms is used herein, the presently disclosed and claimed subject matter may include the use of either of the other two terms. Thus in some embodiments not otherwise explicitly recited, any instance of “comprising” may be replaced by “consisting of” or, alternatively, by “consisting essentially of”

While investigating the positive impacts of electrochemical treatment on astringent wines, it was discovered that some or all of the sulfite content of the wine may be reduced by electrochemical disproportionation (both oxidation and reduction at different electrodes). There is significant evidence given by cyclic voltammetry that sulfite and sulfur dioxide content is being reduced by reactions such as:

HSO₄—+3H⁺+2e⁻=SO₂(aq)+2H₂O (E°=+0.16 V versus SCE)

SO₄²⁻+4H⁺2e—=SO₂(aq)+2H₂O (E°=+0.17 V versus SCE)

SO₂(aq)+4H⁺4e—=S(s)+2H₂O (E°=+0.50 V versus SCE)

where E° is the standard reduction potential at 25° C. and 1 atm versus a saturated calomel electrode (SCE).

Variations of the present invention are premised on efficient and controllable free-radical formation at an electrode surface by applying a direct current electric potential. In order for this to be useful inside a bottle or glass of wine, the following conditions should be met:
1. No gases should be generated (especially hydrogen, chlorine or oxygen). Gas production can be dangerous.
2. The potential should be high enough to generate a wide variety of organic free radicals.
3. Little current should be passed, to avoid significant IR heating or waste power (especially for battery-powered devices).
4. The electrodes should be non-toxic.
5. The electrodes should give no flavor of their own.

Conditions 1 and 2 taken together would indicate that the electrode should have a high overpotential to hydrogen, chlorine, and oxygen. In other words, the electrode pair (anode and cathode) should have a wide potential window in aqueous solution. Most heteroatom and aromatic couples range in standard potential from −1.6 to +1.3 volts (see Wardman, “Reduction Potentials for One-Electron Couples Involving Free Radicals in Aqueous Solution,” J. Phys. Chem. Ref Data, Vol. 18, No. 4, 1989, pp. 1637-1755). Hence, for the widest possible variety of induced electrochemical reactions without H₂, Cl₂, or O₂ generation, an electrochemical window of about 2.9 volts is desirable. Fortunately, the vast majority of these reactions occur between −0.6 volts and +0.8 volts. This is an electrochemical window of only 1.4 volts.

One of the widest potential windows is realized with carbon electrodes. The potential window at neutral pH in 0.1 molar KCl is approximately 2.4 volts. Hence, a large number of organic reactions can be induced without generating significant amounts of gas. If a DC potential of less than 2.4 volts is used with carbon electrodes, a large variety of organic free radicals will be created, without producing any significant quantities of gas and without the need to flow much electrical current. Hence, condition 3 above will also be met with a DC potential less than 2.4 volts. Carbon is non-toxic and, if pure, of no taste. Hence, high-purity graphite or glassy carbon electrodes will meet conditions 4 and 5.

The present invention, in some variations, provides a convenient, power-efficient electrochemical device for accelerating the aging of wine. The device is amenable to in-home use and with a single glass or bottle of wine. The device has surprisingly been shown experimentally (by taste-testing) to be useful for accelerating the aging and thereby improving the taste of wines, including both red and white wines. Wine types include red, white, sparkling, rose, port, sherry, and so on.

Embodiments of the present invention will now be described in detail, including reference to the accompanying figures. The figures provide representative illustration of the invention and are not limiting in their content. It will be understood by one of ordinary skill in the art that the scope of the invention extends beyond the specific embodiments depicted.

In some variations, the invention provides a device for accelerating the aging of wine, the device comprising:
(a) a direct-current electrical potential circuit comprising a solid-state voltage controller, a positive electrode, a negative electrode, and optionally a resistor element;
(b) an electrical power input that is adaptable to an external power supply; and
(c) a switch, in operable communication with the electrical power input, configured to pass electrical current from the external power supply to the positive and negative electrodes,
wherein the positive and negative electrodes are each capable of being at least partially immersed in a selected volume of wine for accelerated aging.

In some embodiments, the solid-state voltage controller is a light-emitting diode, a silicon diode, or a zener diode. For example, the solid-state voltage controller may be a light-emitting diode having a forward voltage drop that is configured to control voltage to the positive and negative electrodes. The solid-state voltage controller may be configured for fixed direct-current voltage control or for variable direct-current voltage control.

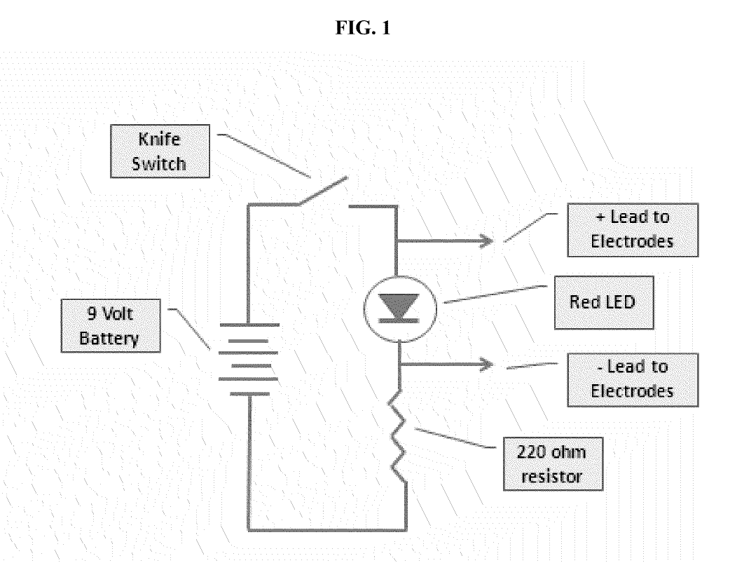

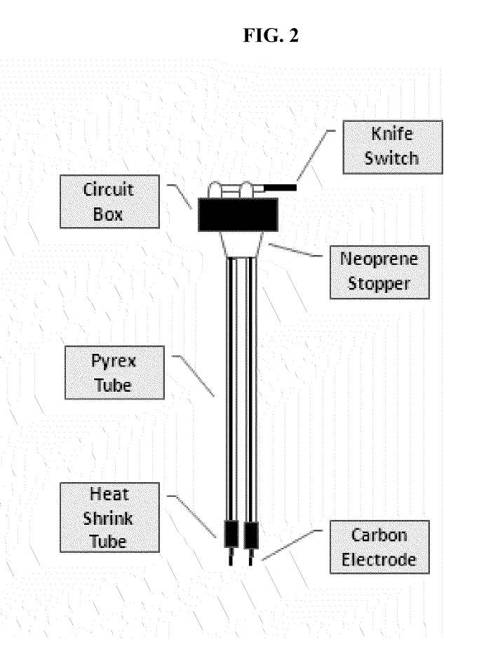

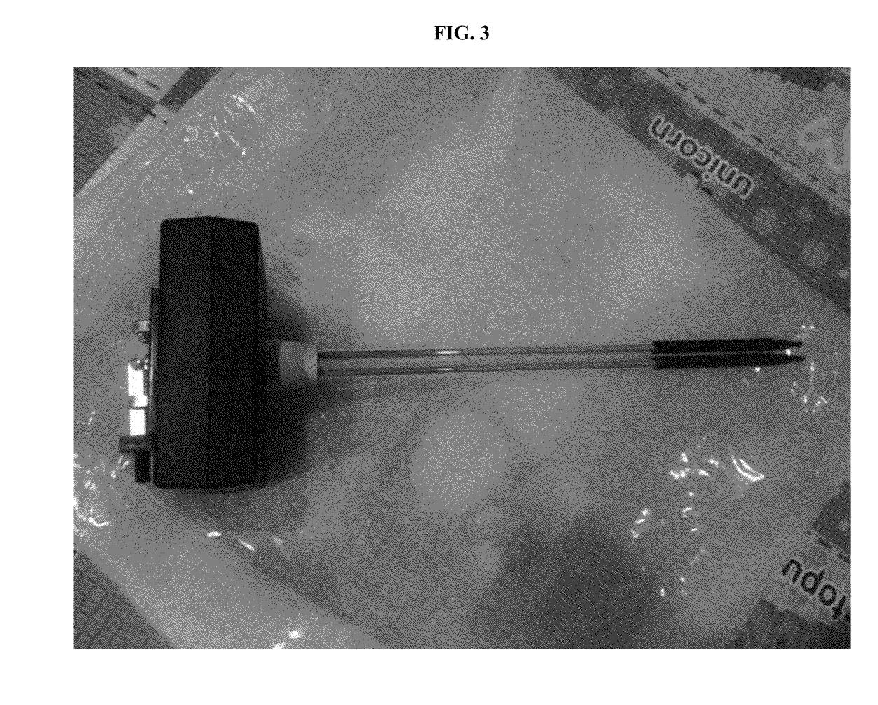

A light-emitting diode (LED) circuit is shown in FIG. 1. A sketch of an exemplary wine-aging device is shown in FIG. 2, and a photograph is shown in FIG. 3 (see Example 1 below).

As a voltage controller, an LED is simple, robust, inexpensive, and uses very little power. An LED has a very stable forward bias potential drop that is related to its color and material of construction. There are a wide variety of LEDs available that could be used for selecting operating voltage. For example, a red LED will have a forward voltage drop of approximately 1.7 volts. Other LEDs may be used to obtain higher voltages. An orange LED, for example, would get closer to the maximum 2.4 volt electrochemical window for carbon electrodes.

The positive electrode and negative electrode may each include one or more materials selected from the group consisting of graphite, glassy carbon, carbon fibers, gold, nickel, titanium, cobalt, and transition-metal oxides. In certain embodiments, the positive electrode and negative electrode each consist essentially of carbon (such as high-purity graphite).

Whereas high-purity graphite has proven to be a very useful electrode material, other electrode materials may be useful. These include metals and semi-conductors that have high over voltage for hydrogen or oxygen (depending on the polarity of the electrode of interest) and are non-toxic. Other materials include but are not limited to glassy carbon, carbon fibers, titanium, gold, nickel, cobalt and many transition-metal oxides. Because amperages are so small, thin coatings of materials (including exotic materials and nanomaterials) on inexpensive substrates (e.g. glass, plastic, etc.) are possible.

In some embodiments, the electrode material consists essentially of graphitic carbon or another electron-conducting carbon. Some examples of electron-conducting carbon include natural graphites, such as flaky graphite, plate-like graphite, and other types of graphite; high-temperature sintered carbon products obtained, for example, from petroleum coke, coal coke, celluloses, saccharides, and mesophase pitch; artificial graphites, including pyrolytic graphite; carbon blacks, such as acetylene black, furnace black, Ketjen black, channel black, lamp black, and thermal black; asphalt pitch, coal tar, active carbon, mesophase pitch, and polyacetylenes.

The positive and negative electrode materials may be independently selected. In some embodiments, the electrode materials are the same, while in other embodiments, the electrode materials are different. For example, a practical portable application (even pocket-sized) utilizes a graphite cathode and a gold anode. The tannins would precipitate on the gold, making it dark in color. The precipitated tannins would easily wipe off. Such a device would use graphite's high overpotential to H₂ and gold's high overpotential for O₂.

Various electrode shapes and sizes may be used, especially those with high useful surface area. Generally, small electrodes may be employed for portable devices and large electrodes may be employed for use in wineries. The reaction rates are clearly dependent on surface area and increased surface area will increase the speed of reaction and capacity of the device to process material. Inexpensive high-purity graphite is available in many shapes (e.g., cylinders) and relatively large sizes. Hence, it is practical to design devices that can process many gallons of product quickly. This can be quite beneficial for use in wineries.

Other electrode configurations may be utilized including “plate and frame” designs which may increase useable surface area dramatically. These can allow very rapid processing similar to single-pass coffee makers. Table-top models may be devised for rapid processing of individual glasses of wine. The same approach could be used to enhance the capacity of a treatment system for application to winery scales.

A wine aging device that uses low-power direct-current voltage and a high-purity graphite electrode system has been shown by taste testing to be useful for improving the taste of many wines at the bottle and glass sizes. This has been demonstrated using very low power (microamps) using inert, high-purity graphite electrodes of cylindrical shape. Detailed testing has elucidated the primary mechanisms for the operation of the device. The device may be scaled up or down using known scaling principles, to the microscale or the macroscale, while maintaining low power requirements.

By “low power” we mean less than 3.0 volts (such as about 1.5 to about 2.5 volts) and in the microamp (typically 20 μA to 100 μA) range for single glass applications; in the milliamp (typically 1 mA to 40 mA) range for single bottle applications; and in the low amp (typically 1 A to 5 A) range for barrel batch size applications. Because of very low power consumption, the device can be battery-powered. For example a standard 9-volt battery is capable of processing hundreds of bottles of wine. The output amperage of these devices may be easily increased using voltage following, higher-power circuits for larger installations, including on-line wine streams at wineries.

In some embodiments of the invention, the external power supply is a battery. In certain embodiments, the battery is a battery within a computer or smartphone itself (such as a smartphone that also has an app to control the device). Also, it is possible that the power source is the direct output from a micro-chip. This is possible for portable devices because the power required is low. Other sources of external power may be utilized, including (but not limited to) solar power, fuel cells, portable generators, AC-to-DC converters (to utilize AC electrical grid power to a house, for example), and so on. Theoretically, portable devices may be made very small and powered by ambient light in the room.

Because power requirements are so small, the device can be made portable (even pocket-sized) and controllable by micro-chips. The device may be controlled remotely by computers by wire or wirelessly. This makes it practical to download shared recipes from centralized databases via a wide variety of computer applications (including smartphone “apps” or software applications). Furthermore, it makes practical a wide variety of automated timing routines including but not limited to starting and stopping the device on a predetermined schedule (e.g. to correspond to when the aged wine needs to be ready) or one that is initiated remotely (e.g. while in transit to home). It also makes possible an incredibly wide array of human interaction and control ranging including indicator lights, screen displays, voice control, and output enunciation.

In some embodiments, the device includes, or is linkable directly or wirelessly to, a microcontroller board and/or a programmable micro-processor chip. In some embodiments, the wine-aging reactions are directly powered by the output pins of a microprocessor. That is, the output pins (ports) of a microprocessor (i.e. microcontroller board or programmable micro-processor chip) may provide both control and electrical power to the device, such as in portable applications. In these or other embodiments, the device further includes an input port on the microcontroller board or the programmable micro-processor chip, configured to sense the aging condition of the selected volume of wine.

Flavor sensations reactions are electrochemical in nature. If the device is micro-chip controllable, it may not only treat the wine using a micro-chip via output ports, it may also sense the condition of the wine electrochemically through micro-chip input ports. This could be done through the main electrodes or special sensing electrodes similar to cyclic voltammetric analysis of wine astringency. Hence, it is practical to program the device to a specific astringency level (for example) and allow the micro-processor to treat the wine to a specific astringency level. See for example Petrovic, “Correlation of Perceived Wine Astringency to Cyclic Voltammetric Response,” American Journal of Enology and Viticulture, September 2009, Vol 6, pp 373-378.

In some embodiments, the forward voltage drop of an LED is utilized to control the voltage supplied to the electrodes of the device. This is an effective method at a convenient voltage drop of about 1.8 volts. Other voltages may also be useful to customize the taste of the aged wine. For example, since sulfites are electrochemically active, it is possible to select a voltage that rapidly reduces sulfites and tannins without seriously impacting beneficial flavors. Hence, it may be beneficial to control the voltage of the circuit at various levels, by configuring the voltage controller for variable direct-current voltage control.

In some embodiments, treatment time is the only user-controllable variable. In some embodiments, the actual current being used by the device may be a good indicator of the actual astringency (especially tannin content) of the wine. Hence, it may be useful to measure the current being supplied to the device and use an absolute current at a specific voltage or an anodic current wave (sweep the voltage and measure the current) as a technique for controlling the endpoint of the desired reactions.

Therefore in some embodiments, additional device features may include the ability to vary the supplied voltage, the ability to measure actual current, and the ability to test the current (absolute or in an anodic wave) and use the test results to control the endpoint of the aging chemistry.

A convenient way to add these features is to use a microcontroller board. These boards can provide control voltages, sense generated voltages, perform simple calculations, and make simple control decisions. In general these boards provide “pseudo-DC” output, have limited current source and sink capabilities, and do not measure current directly. Nevertheless, these limitations can be remedied with simple external hardware. The aging process can be under the complete control of the wine master or sommelier.

One design uses a voltage follower operational amplifier (A1) to supply current to the electrodes of the device. The operating voltage for the system is supplied by an analog output pin from a microcontroller chip. The “pseudo-DC” output (pulsed width modulation, PWM) is converted to true DC using a resistor/capacitor (RC) filter. Typical values of R=1000 ohm and C=1 μF will provided low-ripple DC with an adequate response time for the device. The control voltage may be set by programming the microcontroller to a percentage PWM cycle. In general, it is a percentage of the regulated 5-volt supply to the microcontroller chip. One exemplary operational amplifier that can be used is the LM324. This contains four operational amplifiers in a single package. Each LM324 can typically source or sink 20 milliamps. When for example each device requires only 200 microamps, each of the four LM324 amplifiers could drive up to 100 devices simultaneously.

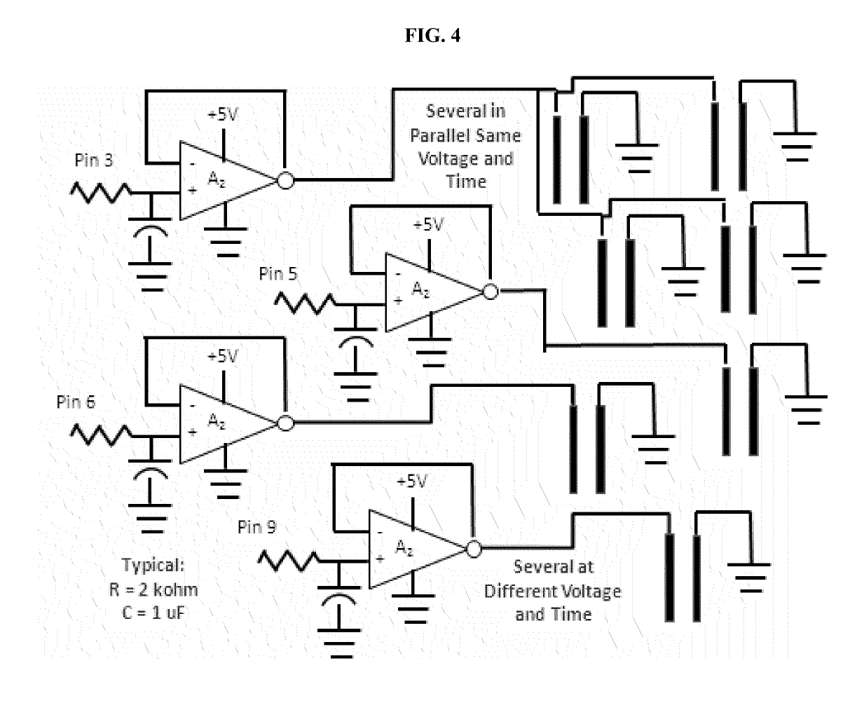

The desired voltage and run time can be set by software that loads parameters to the microcontroller. The software can run on a wide variety of devices including but not limited to PCs and smartphones. Communication between the controlling device and the device may be accomplished by a wide variety of methods including USB, RS232, Bluetooth, WiFi, and others. Voltage could range from 0 to 5 volts, but the most useful voltages will typically be between 0.5 and 2.2 volts. Lower voltage may not remove tannins and higher voltages may result in the undesirable generation of hydrogen and oxygen (electrolysis). FIG. 4 shows an example circuit using an ATmega 328 microcontroller and an LM324 operational amplifier (using all four of the LM324 amplifiers). It illustrates that multiple sets can be run at different times and voltages. Furthermore, multiple sets can be run at the same time and voltages.

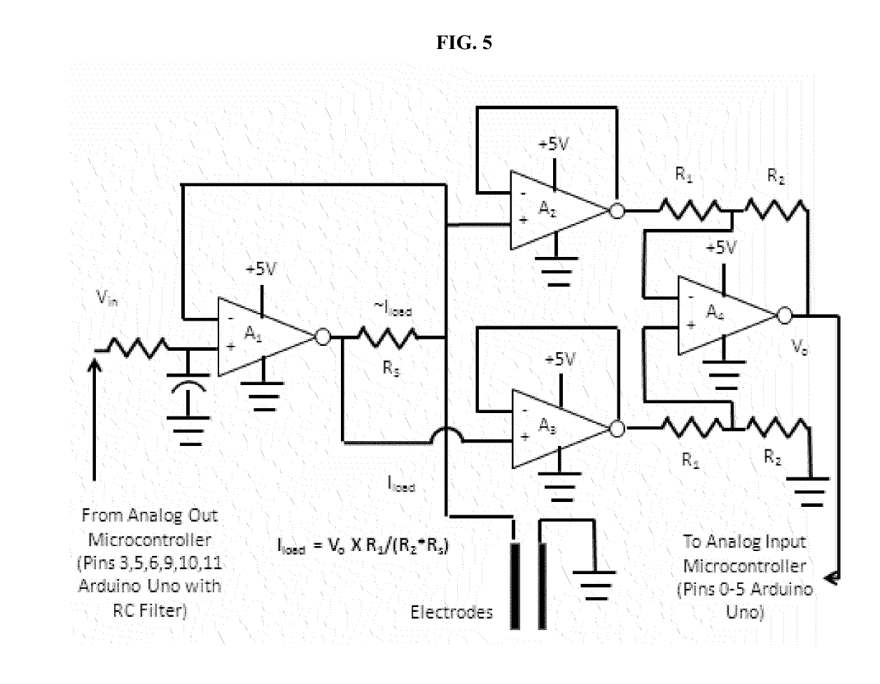

In operation, the desired operating voltages and run times may be downloaded to the microcontroller chip via several well-established means including those described above. The run time of the wine-aging device may also be downloaded to the microcontroller chip. These parameters may be manually entered into the control program (IDE being one of such programs) using any number of devices capable of communicating with the microcontroller chip via the well-established means listed above. Such input devices include PCs, smartphones, and even external databases where these parameters may reside and can be downloaded directly to the device or to intermediate devices such as PCs, smartphones, etc. Once these parameters are downloaded to the device, the microcontroller will operate even if disconnected from the controlling device. The circuit in FIG. 4 provides control based on voltage and time. The same microcontroller can provide control based on voltage and current, such as illustrated by the circuit of FIG. 5.

The “computer” utilized in some embodiments, with the wine-aging device, is any programmable computing device, or plurality of devices which may be distributed in time or space, capable of being programmed (such as using C++ programming language) or otherwise caused to execute code for executing the steps of any of the methods or algorithms described herein. The algorithm may be embedded within a controller.

In some embodiments, the computer has a processor, an area of main memory for executing program code under the direction of the processor, a storage device for storing data and program code and a bus connecting the processor, main memory, and the storage device; the code being stored in the storage device and executing in the main non-transient memory under the direction of the processor, to perform the steps of the methods or algorithms recited in this description. Optionally, the computer may be configured to exchange data with a network (such as the Internet), and may carry out calculations on remote computers, servers, or via cloud computing.

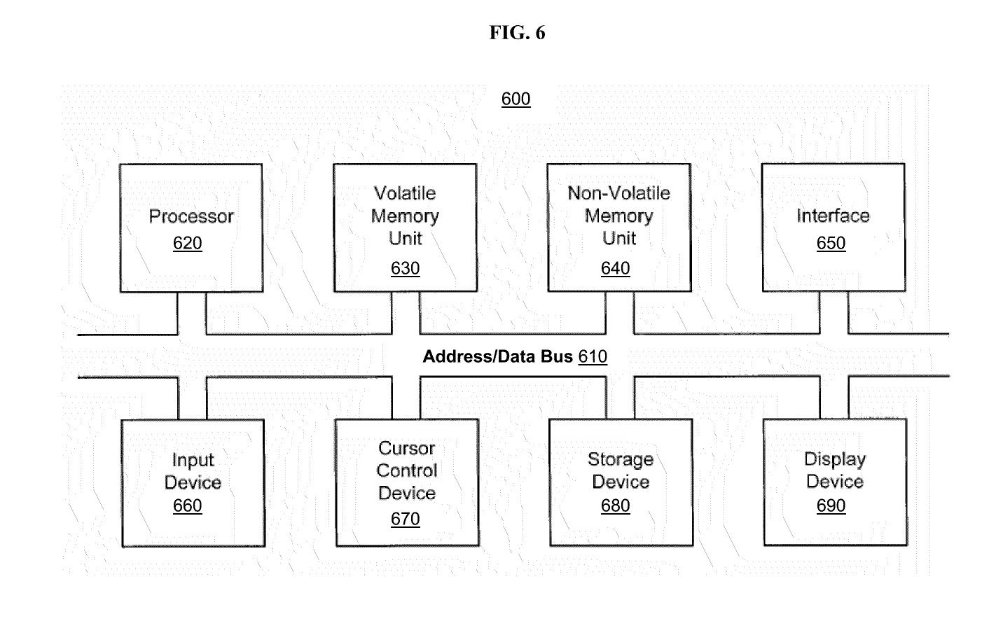

An exemplary computer system 600 in accordance with some embodiments is shown in FIG. 6. Exemplary computer system 600 is configured to perform calculations, processes, operations, and/or functions associated with a program or algorithm. In some embodiments, certain processes and steps discussed herein are realized as a series of instructions (e.g., software program) that reside within computer-readable memory units and are executed by one or more processors of exemplary computer system 600. When executed, the instructions cause exemplary computer system 600 to perform specific actions and exhibit specific behavior, such as described herein.

Exemplary computer system 600 may include an address/data bus 610 that is configured to communicate information. Additionally, one or more data processing units, such as processor 620, are coupled with address/data bus 610. Processor 620 is configured to process information and instructions. In some embodiments, processor 620 is a microprocessor. Alternatively, processor 620 may be a different type of processor such as a parallel processor, or a field-programmable gate array.

Exemplary computer system 600 is configured to utilize one or more data-storage units. Exemplary computer system 600 may include a volatile memory unit 630, such as (but not limited to) random access memory (“RAM”), static RAM, or dynamic RAM, coupled with address/data bus 610, wherein volatile memory unit 630 is configured to store information and instructions for processor 620. Exemplary computer system 600 further may include a non-volatile memory unit 640, such as (but not limited to) read-only memory (“ROM”), programmable ROM (“PROM”), erasable programmable ROM (“EPROM”), electrically erasable programmable ROM “EEPROM”), or flash memory coupled with address/data bus 610, wherein non-volatile memory unit 640 is configured to store static information and instructions for processor 620. Alternatively exemplary computer system 600 may execute instructions retrieved from an online data-storage unit such as in “cloud computing.”

In some embodiments, exemplary computer system 600 also may include one or more interfaces, such as interface 650, coupled with address/data bus 610. The one or more interfaces are configured to enable exemplary computer system 600 to interface with other electronic devices and computer systems. The communication interfaces implemented by the one or more interfaces may include wireline (e.g., serial cables, modems, network adaptors, etc.) and/or wireless (e.g., wireless modems, wireless network adaptors, etc.) communication technology.

In some embodiments, exemplar computer system 600 may include an input device 660 coupled with address/data bus 610, wherein input device 660 is configured to communicate information and command selections to processor 620. In accordance with certain embodiments, input device 660 is an alphanumeric input device, such as a keyboard, that may include alphanumeric and/or function keys. Alternatively, input device 660 may be an input device other than an alphanumeric input device. In some embodiments, exemplar computer system 600 may include a cursor control device 670 coupled with address/data bus 610, wherein cursor control device 670 is configured to communicate user input information and/or command selections to processor 620. A cursor control device 670 may be implemented using a device such as a mouse, a track-ball, a track-pad, an optical tracking device, or a touch screen. A cursor control device 670 may alternatively, or additionally, be directed and/or activated via input from input device 660, such as in response to the use of special keys and key sequence commands associated with input device 660. Alternatively, or additionally, cursor control device 670 may be configured to be directed or guided by voice commands.

In some embodiments, exemplary computer system 600 further may include one or more optional computer-usable data-storage devices, such as storage device 680, coupled with address/data bus 610. Storage device 680 is configured to store information and/or computer-executable instructions. In some embodiments, storage device 680 is a storage device such as a magnetic or optical disk drive, including for example a hard disk drive (“HDD”), floppy diskette, compact disk read-only memory (“CD-ROM”), or digital versatile disk (“DVD”). In some embodiments, a display device 690 is coupled with address/data bus 610, wherein display device 690 is configured to display video and/or graphics. Display device 690 may include a cathode ray tube (“CRT”), liquid crystal display (“LCD”), field emission display (“FED”), plasma display or any other display device suitable for displaying video and/or graphic images and alphanumeric characters recognizable to a user.

Exemplary computer system 600 is presented herein as an exemplary computing environment in accordance with some embodiments. However, exemplary computer system 600 is not strictly limited to being a computer system. For example, exemplary computer system 600 may represent a type of data processing analysis that may be used in accordance with various embodiments described herein. Moreover, other computing systems may also be implemented. Indeed, the spirit and scope of the present technology is not limited to any single data processing environment. Thus, in some embodiments, one or more operations of various embodiments are controlled or implemented using computer-executable instructions, such as program modules, being executed by a computer. Such program modules may include routines, programs, objects, components and/or data structures that are configured to perform particular tasks or implement particular abstract data types. In addition, in some embodiments, one or more aspects are implemented by utilizing distributed computing environments, such as where tasks are performed by remote processing devices that are linked through a communications network, or such as where various program modules are located in both local and remote computer-storage media including memory-storage devices.

In addition to the functional features of the device, various ornamental (design) options are possible. Because the operating portions of the device can be miniaturized, it becomes practical to house the device in a wide variety of “designer packages” including three-dimensional representations of logos, mascots, historical figures, and a wide variety of figurines, etc.

The present invention, in some variations, provides a method of accelerating the aging of wine, the method comprising:
(a) selecting a volume of wine to be aged;
(b) providing a direct-current electrical potential circuit comprising a solid-state voltage controller (such as a light-emitting diode), a positive electrode, a negative electrode, and optionally a resistor element;
(c) at least partially immersing the positive and negative electrodes into the volume of wine;
(d) passing electrical current from an external power supply to the positive and negative electrodes, to induce free-radical formation at an electrode surface; and
(e) treating the volume of wine for an effective amount of time to age the wine.

In some embodiments, in step (d), direct-current voltage (arising from the direct-current electrical potential circuit) is less than 3.0 volts, such as about 2.4 volts or less. In certain embodiments, the direct-current voltage is about 1.8 volts or less. In various embodiments, the direct-current voltage is about 0.5, 1.0, 1.1, 1.2, 1.3, 1.4, 1.5, 1.6, 1.7, 1.8, 1.9, 2.0, 2.1, 2.2, 2.3, 2.4, or 2.5 volts.

The electrical current amperage in step (d) may vary, depending on the volume of wine to be treated, as well as on the desired amount of aging. When the volume of wine is a glass of wine, the electrical current in step (d) may be selected from about 20 μA to about 100 μA. When the volume of wine is a bottle of wine, the electrical current in step (d) may be selected from about 1 mA to about 40 mA. When the volume of wine is a barrel or vessel of wine, the electrical current in step (d) may be selected from about 1 A to about 5 A.

The free-radical formation induced in step (d) may be effective to remove tannins by precipitation or other chemical reactions and/or to remove sulfites by disproportionation or other chemical reactions. The free-radical formation may be effective to initiate other chemical reactions.

The effective amount of time in step (e) may be selected from about 1 minute to about 60 minutes, such as about 5 minutes to about 30 minutes. In various embodiments, the effective amount of time may be about 2, 5, 10, 15, 20, 25, 30, 40, or 50 minutes. With a suitable electrode configuration and power settings, it is possible for the effective amount of time to be less than 1 minute, such as 10-30 seconds (e.g. in a table-top configuration similar to a single-serve coffee pot).

In some embodiments, the method further comprises retrieving, from a remote database, recipe instructions or control parameters pertaining to one or more of steps (b) to (e). The remote database may be stored on a server computer, or in the cloud, for example, and the retrieval may be performed over the Internet.

The method may utilize a device comprising:
(a) a direct-current electrical potential circuit comprising a solid-state voltage controller, a positive electrode, a negative electrode, and optionally a resistor element;
(b) an electrical power input that is adaptable to an external power supply; and
(c) a switch, in operable communication with the electrical power input, configured to pass electrical current from the external power supply to the positive and negative electrodes,
wherein the positive and negative electrodes are each capable of being at least partially immersed in a selected volume of wine for accelerated aging.

In some embodiments, the method further comprises sensing an aging condition of the volume of wine. For example, the device may further include a microcontroller board or programmable micro-processor chip, configured to sense the aging condition of the selected volume of wine while it is being treated.

The invention also provides a wine product produced by a process comprising:
(a) selecting a volume of wine to be aged;
(b) providing a direct-current electrical potential circuit comprising a solid-state voltage controller (such as a light-emitting diode), a positive electrode, a negative electrode, and optionally a resistor element;
(c) at least partially immersing the positive and negative electrodes into the volume of wine;
(d) passing electrical current from an external power supply to the positive and negative electrodes, to induce free-radical formation at an electrode surface; and
(e) treating the volume of wine for an effective amount of time to age the wine, thereby producing a wine product.

Because the device has been shown to be useful for destroying sulfites, it may be applicable for wine users who are sensitive to sulfites. This could expand the wine market to users who might otherwise not be able to consume wine.

Some embodiments provide computer-readable medium containing program instructions for accelerating aging of wine, wherein execution of said program instructions by one or more processors of a computer causes said one or more processors to cause electrical current to pass from an external power supply to positive and negative electrodes in a direct-current electrical potential circuit with a solid-state voltage controller, to induce free-radical formation at an electrode surface, for an effective amount of time to age the wine.

In certain embodiments, additional data inputs (beyond current and voltage) are considered in the model and algorithms. Additional data inputs may relate to ambient conditions of the local environment, including temperature, pressure, and relative humidity, for instance. Additional data inputs may be based on previous experience with similar wines, or other ways to capture prior knowledge to improve the accuracy of the method for the intended purpose. These additional data inputs may be quantitative or qualitative in nature.

In some embodiments, a batch of wine is taste-tested by a wine master to create a unique flavor or flavor profile. During large-scale production, a circulation loop may be employed to continuously or periodically treat a stream of wine, which is then sent back to a main vessel for storage or further processing.

The wine-aging device may alter one or more wine-tasting perceptions, including (but not limited to) front, middle, or finish. The first taste, or impression, of the wine when it lands in the mouth of a person is known as “front” (also known as upfront, forward, entry, or attack). The specific timing associated with this initial taste can be about 1-10 seconds after the wine first enters the mouth. The “middle” is the taste experienced as the wine is held in the mouth. Middle is also known as mid-palate, or even simply palate. In this middle palate location, the consumer may swirl, bite, chew, and/or move the wine around in the mouth, then let it settle. Such actions are known in the art as “aerating” the wine. Typically, middle begins about 6-20 seconds after the first wine entry into the mouth. The “finish” is the taste experienced at the point of and/or just after swallowing. Finish is also known as aftertaste or length. Typically, finish begins about 10 seconds to about 1 minute after first wine entry into the mouth.

### EXAMPLES

The following experiments demonstrate the principles of this invention. The wine-aging device has been shown by taste-testing to be useful for improving the taste of many wines at the bottle and glass size using fixed and variable direct-current voltage control. This has been demonstrated using very low power (microamps) using inert, high-purity graphite electrodes of cylindrical shape.

### Example 1

### Construction of Prototype Wine-Aging Device.

A prototype was built used a red LED with a forward voltage drop of approximately 1.7 volts and an open-circuit amperage of about 23 mA through the LED. A working prototype of the device was constructed in the laboratories of Stites & Associates, LLC. This prototype was sized to treat a full bottle of wine. The device was built using a 9-volt battery, a knife switch, a plastic circuit box, a neoprene stopper, two copper coated ⅛″ diameter carbon “gouging rods,” two ¼″ pyrex glass tubes, a red LED, a 220-ohm resistor, wire, J-B weld, and heat shrinkable tubing. The produced voltage to the carbon electrodes was approximately 1.7 volts and was stable. The amperage through the LED was approximately 23 mA. A sketch of this device is shown in FIG. 2, and a photograph is shown in FIG. 3.

### Example 2

### Initial Taste-Testing Using Wine-Aging Device.

The device in Example 1 was used to test the efficacy, as follows. Two of the present inventors taste-tested the results from using the device with a red wine, and a smoother taste was detected after 15 minutes of treatment. Taste-testing with another red wine was repeated at a later date, and three of the four taste testers agreed that the wine was improved.

### Example 3

### Construction of Additional Wine-Aging Devices.

Additional prototypes were then constructed using high-purity graphite electrodes and food-grade shrink tubing. Connections to the high-purity graphite were made using a copper electrode strike technique.

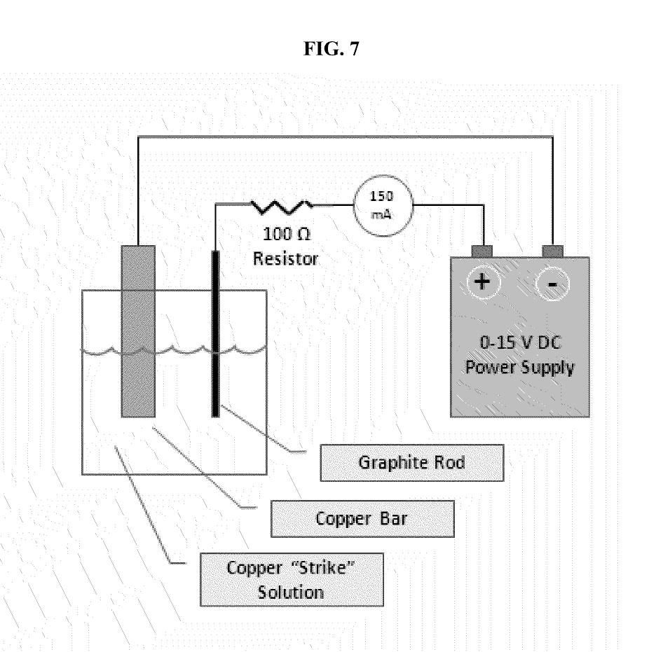

A copper strike solution was prepared with 600 mL distilled water, 94 grams of CuSO₄·5H₂O, and 50 mL concentrated H₂SO₄. A procedure as follows was then employed:
1. Clean ends of graphite rods by wiping off loose carbon and heating the end to a dull red using a propane torch or similar flame heating device.
2. Set up copper strike bath, as depicted in FIG. 7.
3. Plate as follows:
   a. 150 mA 2 minutes
   b. Reverse at 50 mA for 30 seconds
   c. 150 mA 5 minutes
   d. Reverse at 50 mA for 30 seconds
   e. 150 mA for 10 minutes
   f. Rinse and Dry
4. Wind 1″ of 16 WG solid copper wire around ⅛″ drill shank leaving a 6″ pigtail
5. Screw wound wire onto copper strike
6. Solder with resin fluxed lead solder

Other formulas and methods for attaching a wire to the high-purity graphite may be used.

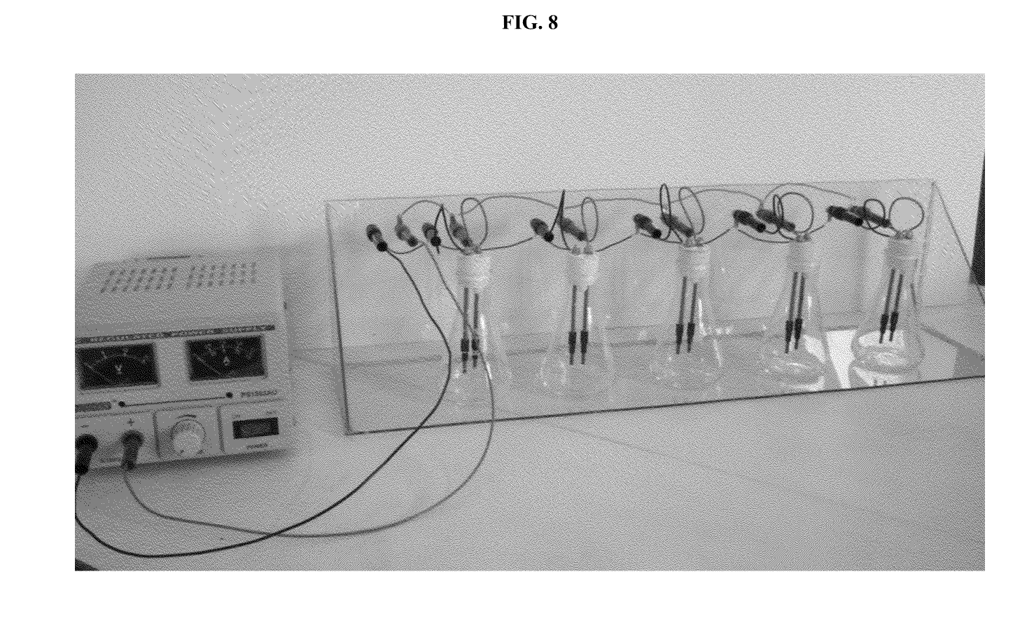

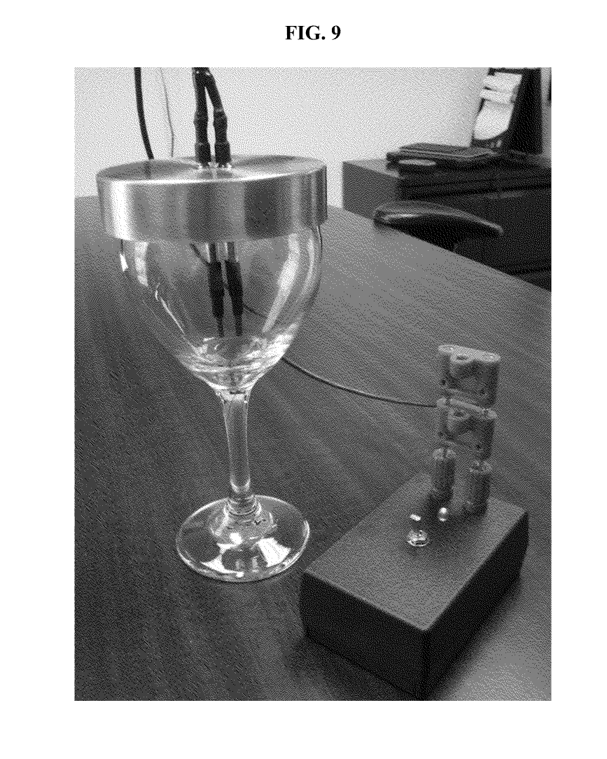

This procedure was used to make additional prototypes including 5-position test rigs (see FIG. 8) and a single-glass model (see FIG. 9). In addition to these prototypes, several electrodes were made for fundamental testing using cyclic voltammetry.

### Example 4

### Taste-Testing Using Wine-Aging Device.

The 5-position test rigs in Example 3 were used to test efficacy of wine aging, as follows. Three 5-position test rigs were used for taste-testing trials. These occurred in Arvada, Col., Denver, Col., and Idaho Falls, Id. At one taste-testing event, over 45 persons were present for the trial. A total of nearly 200 people were allowed to taste-test a wide variety of wines. With few exceptions users agreed that full-bodied, young red wines were made much less astringent and far more palatable when treated for 10 to 20 minutes. In a surprising number of cases, even white wines were often found to be more palatable.

### Example 5

### Cyclic Voltammetry Testing of Wine-Aging Device.

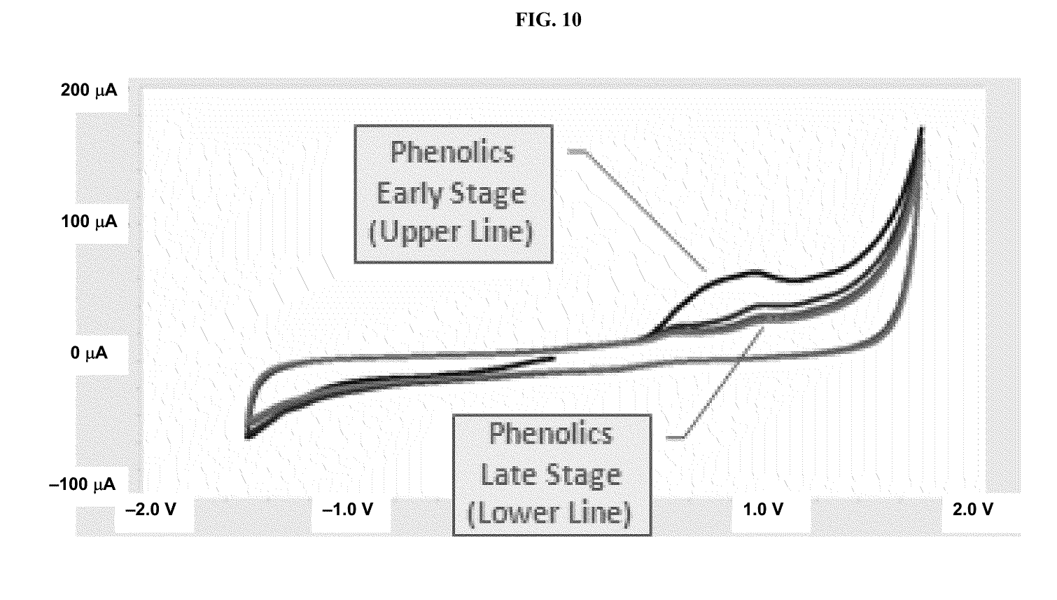

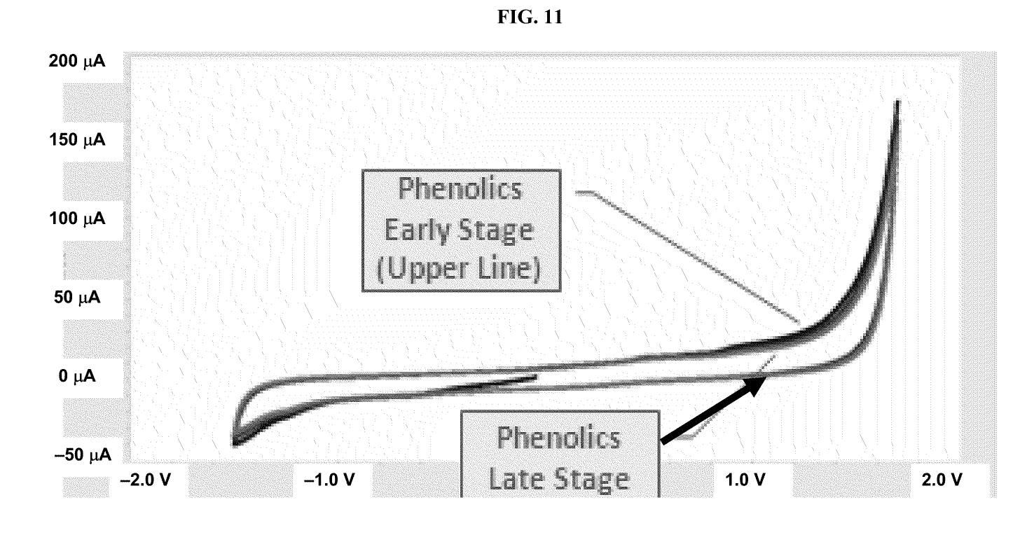

Cyclic voltammetry testing indicated that the device was precipitating tannins—especially from red wines. These data are shown graphically for red and white wines in FIG. 10 (red wine) and FIG. 11 (white wine). The mechanism for taste improvement is therefore believed to be, at least in part, removal of tannins by initiating and accelerating reactions similar to those found in natural aging.

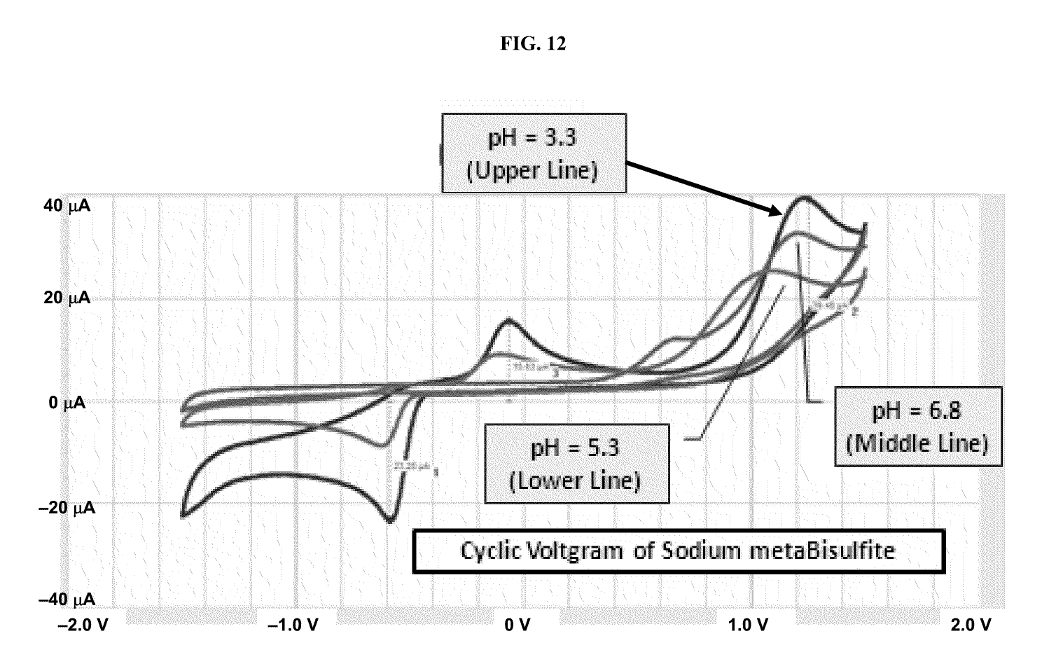

Additional cyclic voltammetry testing on a sulfite solution showed that the same electrodes disproportionated the sulfite. This process destroyed the sulfite (converting to sulfate and sulfur) and may have been an important mechanism for improving taste, especially for low-tannin white wines. These data are shown in FIG. 12.

### Example 6

Wine-Aging Device with Microprocessor Board.

Tests were also performed using an Arduino microprocessor board to demonstrate the ability of the system to work at a micro-scale. Typical circuits are shown in FIGS. 2 and 3. It was demonstrated that the power from a microprocessor chip was sufficient to operate multiple wine-aging devices. Hence, wine-aging devices can easily be controlled by smartphones, PCs, tablets, or other computerized devices. This also makes feasible the applications that link users together and allows the sharing of wine aging “recipes” through applications and databases.

There are a wide variety of practical and commercial uses for the present invention. Applications include, but are not limited to, red wines, white wines, liquors and spirits, teas, coffees, medicinal extracts, water (such as for water treatment), and other foods or beverages. Because the device directly impacts flavor-creating materials (tannins, flavinoids, other polyphenols, etc.), the device may be applied to other foods and beverages including but not limited to other liquors and spirits, teas, coffees, medicinal extracts and even bad-tasting water (such as from surface runoff contaminated with tannins)

In some variations, the invention also provides a device for accelerating the aging (or other beneficial chemical reaction) of a food or beverage, the device comprising:
(a) a direct-current electrical potential circuit comprising a solid-state voltage controller, a positive electrode, a negative electrode, and optionally a resistor element;
(b) an electrical power input that is adaptable to an external power supply; and
(c) a switch, in operable communication with the electrical power input, configured to pass electrical current from the external power supply to the positive and negative electrodes,
wherein the positive and negative electrodes are each capable of being at least partially immersed in a selected volume of a food or beverage for accelerated aging.

The invention, in some variations, also provides a method of accelerating the aging (or other beneficial chemical reaction) of a food or beverage, the method comprising:
(a) selecting a volume of a food or beverage to be aged;
(b) providing a direct-current electrical potential circuit comprising a solid-state voltage controller (such as a light-emitting diode), a positive electrode, a negative electrode, and optionally a resistor element;
(c) at least partially immersing the positive and negative electrodes into the volume of the food or beverage;
(d) passing electrical current from an external power supply to the positive and negative electrodes, to induce free-radical formation at an electrode surface; and
(e) treating the volume of the food or beverage for an effective amount of time to age the food or beverage.

Because the device has been shown to be useful for destroying sulfites, it may be applicable to other food and beverage markets where sulfites could be useful for sterilization and preservation. High levels of sulfites are very effective at sterilization, but can be quite obnoxious and even toxic to humans. Removal of sulfites before consumption may be an effective way to sterilize and preserve a wide variety of foods and beverages.

In this detailed description, reference has been made to multiple embodiments and to the accompanying drawings in which are shown by way of illustration specific exemplary embodiments of the invention. These embodiments are described to enable those skilled in the art to practice the invention, and it is to be understood that modifications to the various disclosed embodiments may be made by a skilled artisan.

Where methods and steps described above indicate certain events occurring in certain order, those of ordinary skill in the art will recognize that the ordering of certain steps may be modified and that such modifications are in accordance with the variations of the invention. Additionally, certain steps may be performed concurrently in a parallel process when possible, as well as performed sequentially.

All publications, patents, and patent applications cited in this specification are herein incorporated by reference in their entirety as if each publication, patent, or patent application were specifically and individually put forth herein.

The embodiments, variations, and figures described above should provide an indication of the utility and versatility of the present invention. Other embodiments that do not provide all of the features and advantages set forth herein may also be utilized, without departing from the spirit and scope of the present invention. Such modifications and variations are considered to be within the scope of the invention defined by the claims.

What is claimed is:

1. A device for accelerating the aging of wine, said device comprising:
(a) a direct-current electrical potential circuit comprising a solid-state voltage controller, a positive electrode, and a negative electrode;
(b) an electrical power input that is adaptable to an external power supply; and
(c) a switch, in operable communication with said electrical power input, configured to pass electrical current from said external power supply to said positive and negative electrodes,
wherein said positive and negative electrodes are each capable of being at least partially immersed in a selected volume of wine for accelerated aging.

2. The device of claim 1, wherein said solid-state voltage controller is a light-emitting diode, a silicon diode, or a zener diode.

3. The device of claim 2, wherein said solid-state voltage controller is a light-emitting diode having a forward voltage drop that is configured to control voltage to said positive and negative electrodes.

4. The device of claim 1, wherein said solid-state voltage controller is configured for fixed direct-current voltage control.

5. The device of claim 1, wherein said solid-state voltage controller is configured for variable direct-current voltage control.

6. The device of claim 1, wherein said direct-current electrical potential circuit further includes at least one resistor element.

7. The device of claim 1, wherein said positive electrode and negative electrode each independently include one or more materials selected from the group consisting of graphite, glassy carbon, carbon fibers, gold, nickel, titanium, cobalt, and transition-metal oxides.

8. The device of claim 7, wherein said positive electrode and negative electrode each consist essentially of carbon.

9. The device of claim 1, wherein said external power supply is a battery.

10. The device of claim 1, wherein said device is portable.

11. The device of claim 1, wherein said device includes, or is linkable directly or wirelessly to, a microcontroller board and/or a programmable micro-processor chip.

12. The device of claim 11, wherein said device further includes one or more output ports on said microcontroller board or said programmable micro-processor chip, configured to provide both control and electrical power to said device.

13. The device of claim 11, wherein said device further includes one or more input ports on said microcontroller board or said programmable micro-processor chip, configured to sense the aging condition of said selected volume of wine.

14. A method of accelerating the aging of wine, said method comprising:
(a) selecting a volume of wine to be aged;
(b) providing a direct-current electrical potential circuit comprising a solid-state voltage controller, a positive electrode, and a negative electrode;
(c) at least partially immersing said positive and negative electrodes into said volume of wine;
(d) passing electrical current from an external power supply to said positive and negative electrodes, to induce free-radical formation at an electrode surface; and
(e) treating said volume of wine for an effective amount of time to age said wine.

15. The method of claim 14, wherein in step (d), direct-current voltage is less than 3.0 volts.

16. The method of claim 15, wherein said direct-current voltage is about 2.4 volts or less.

17. The method of claim 16, wherein said direct-current voltage is about 1.8 volts or less.

18. The method of claim 14, wherein said solid-state voltage controller is a light-emitting diode.

19. The method of claim 14, wherein said free-radical formation is effective to remove tannins by precipitation or other chemical reactions.

20. The method of claim 14, wherein said free-radical formation is effective to remove sulfites by disproportionation or other chemical reactions.

21. The method of claim 14, wherein said volume of wine is a glass of wine, and wherein said electrical current in step (d) is selected from about 20 μA to about 100 μA.

22. The method of claim 14, wherein said volume of wine is a bottle of wine, and wherein said electrical current in step (d) is selected from about 1 mA to about 40 mA.

23. The method of claim 14, wherein said volume of wine is a barrel or vessel of wine, and wherein said electrical current in step (d) is selected from about 1 A to about 5 A.

24. The method of claim 14, wherein said effective amount of time is from about 1 minute to about 60 minutes.

25. The method of claim 14, said method further comprising sensing an aging condition of said volume of wine.

26. The method of claim 14, said method further comprising retrieving, from a remote database, recipe instructions or control parameters pertaining to one or more of steps (b) to (e).
